(19) United States
(12) Patent Application Publication
(10) Pub. No.: US 2023/0202688 A1
(43) Pub. Date: Jun. 29, 2023

(54) VERTICAL TAKEOFF AND LANDING (VTOL) AIRCRAFT SYSTEM AND METHOD

(71) Applicant: Corvidair Inc., Walnut, CA (US)

(72) Inventors: Barnaby Wainfan, Independence, OR (US); Star Simpson, Covina, CA (US)

(21) Appl. No.: 18/087,153

(22) Filed: Dec. 22, 2022

Related U.S. Application Data
(60) Provisional application No. 63/293,807, filed on Dec. 26, 2021.

(51) Int. Cl. B64U 30/295; B64U 10/20; B64U 50/19

(52) U.S. Cl. CPC B64U 30/295; B64U 10/20; B64U 50/19

(57) ABSTRACT

A method of operating an aircraft including takeoff of an aircraft; transitioning the aircraft to a forward flight configuration by increasing an amount of forward propulsive force generated by a propeller assembly from equal to or less than 10% to at least 80% of a propeller assembly maximum and reducing the upward propulsive force generated by rotor assemblies from at least 80% of a rotor assembly maximum to equal to or less than 10%; flying the aircraft from a first location to a second location in the forward flight configuration; and transitioning the aircraft to a landing configuration at the second location by decreasing an amount of forward propulsive force generated by the propeller assembly and increasing the upward propulsive force generated by the rotor assemblies.

### CROSS-REFERENCE TO RELATED APPLICATIONS

This application is a non-provisional of and claims the benefit of U.S. Provisional Application No. 63/293,807, filed Dec. 26, 2021, entitled “VERTICAL TAKE-OFF AND LANDING (VTOL) AIRCRAFT.” This application is hereby incorporated herein by reference in its entirety and for all purposes.

### BRIEF DESCRIPTION OF THE DRAWINGS

FIG. 1 depicts a side isometric view of an aircraft in accordance with an embodiment.

FIG. 2 depicts a front isometric view of an aircraft in accordance with an embodiment.

FIG. 3 depicts a rear isometric view of an aircraft in accordance with an embodiment.

FIG. 4 depicts a bottom isometric view of an aircraft in accordance with an embodiment.

FIG. 5 depicts a side view of an aircraft in accordance with an embodiment.

FIG. 6 depicts a front view of an aircraft in accordance with an embodiment.

FIG. 7 depicts a rear view of an aircraft in accordance with an embodiment.

FIG. 8 depicts a bottom view of an aircraft in accordance with an embodiment.

FIG. 9 depicts a top view of an aircraft in accordance with an embodiment.

FIG. 10 depicts an aircraft in flight in accordance with an embodiment.

FIG. 11 depicts an example embodiment of an aircraft making a vertical takeoff at a first location, flying in to a second location and making a vertical landing.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

Various embodiments of the present disclosure relate to vertical takeoff and landing (VTOL) and other aircraft. VTOL aircraft can include helicopters, gyroplanes, and electric multi-rotor drones. A transverse-rotor helicopter can employ mounted rotors but in various examples can lack usefully-lifting wing elements and separate cruise propulsion motors. Some vehicles or aircraft can be powered by single motors that drive the rotors through a complex transmission, without a hybrid-propulsion aspect, which may be undesirable in some embodiments. Some vehicles use electric rotors for takeoff and then stop the rotors and cruise wing-borne. Some compound rotorcraft can have lifting wings and the ability to use propellers for forward thrust in cruise, but they are single-rotor configurations and also do not use hybrid propulsion, which may not be desirable in some embodiments. Some aircraft either fly solely on rotor lift, or shut down the rotors entirely in cruise flight, which may not be desirable in some embodiments.

Various preferred embodiments of the present disclosure include a VTOL vehicle or aircraft capable of more efficient cruising flight. Such an aircraft can have a blended-wing main body, a pair of tip-mounted, electrically powered rotors, a boom mounted tail, and a tractor propeller driven by an internal-combustion engine for cruise and loiter propulsion. Various examples are capable of powered vertical takeoff and zero-roll landing without incorporating the capability to perform steady-state hover. Some embodiments can include a compound configuration that combines low power to lift-off of low disk loading with efficient loiter performance.

The VTOL vehicle of various embodiments can have a compound configuration: for example, a blended-wing main body with a pair of tip-mounted, electrically powered rotors that provide vertical thrust for takeoff and landing, a twin-boom mounted tail, and a single tractor propeller that is driven by an internal-combustion engine for cruise and loiter propulsion. In various embodiments, a blended wing/body carries the payload, fuel, batteries, and systems and provides efficient lift in cruising flight. The blended center body can be configured to be aerodynamically and structurally efficient. In various embodiments a blended center body can provide low drag aerodynamic performance, light weight and sufficient stiffness to be aeroelastically stable with the tip-mounted rotors spinning. This can provide an efficient airframe designed for wingborne forward flight.

Various embodiments can include wing-mounted ailerons that control the aircraft in roll in cruise. The aircraft can include an empennage (e.g., tail), mounted on a boom in a preferred embodiment that stabilizes the aircraft in flight and provides control in pitch and yaw. The empennage can include a vertical tail (e.g., fin) with rudders to control the aircraft's yaw and a horizontal tail with an elevator to control its pitch.

In various embodiments, a hybrid lift/propulsion system can incorporate electrically-driven wing-tip mounted lift rotors for vertical lift and a nose-mounted cruise thrust propeller driven by an internal combustion engine (ICE) for horizontal cruise propulsion. Such a hybrid system in various examples uses the optimal technology for each piece of the propulsion requirements: the lift system exploits the high power and rapid response that electric motors provide and the cruise ICE exploits the superior energy density of hydrocarbon fuel to provide maximum range. The rotors can provide vertical thrust for takeoff and landing. The propeller (or propellers), driven by an internal combustion engine or, alternatively, an electric motor, can propel the aircraft horizontally in cruising flight.

Rotors in various embodiments can provide vertical lift for jump takeoff and vertical landing, and can also operate in a different mode in some examples that improves aerodynamic efficiency in cruising flight when the majority of the lift is being produced by the wing. Unlike some systems, the aircraft of some embodiments does not lift off into a steady-state hover, and does not have the complex controls or rotor systems needed to hover steady-state. The takeoff can be a dynamic transient “jump” maneuver. Similarly, the aircraft of various embodiments does not hover to land. For example, in some embodiments, a burst of rotor thrust can be used to arrest vertical and forward motion just before touchdown. The approach to landing can be near-vertical in autorotation in some examples with an electric power burst to arrest the final sink rate.

In some embodiments, rotors on the top of the wings can rotate slowly (either lightly powered or in autorotation) carrying a small amount of lift and working synergistically with the wing in cruise flight powered by propeller. Because the wing rotors can be tip-mounted on the wing, in loiter, the lift of the rotors increases the effective span of the wing, reducing induced drag of the wing, the rotors, and rotor nacelles. The rotors in various embodiments can be positioned to have a favorable effect on cruise efficiency instead of being parasitic.

Tip-mounted rotors of various embodiments can act as a high-lift system to get the efficient aircraft airframe airborne. The rotors may be fixed pitch or have collective pitch control, which may remove the need for cyclic pitch control in some examples. Various configurations of rotor (blade shape, number of blades) can be employed in various embodiments. The number of cruise propulsion engines (e.g., propellers) can be one or more. Various types of cruise propulsion engine can be used in various embodiments, including internal combustion, electric, jet, ducted fan.

A variety of suitable tail configurations can be used in various embodiments; for example, with one or more vertical fins, T-tail, or V-tail configurations. The aircraft can function without a horizontal tail in some embodiments. In some preferred embodiments, the tail may be mounted on twin booms, or on any suitable type of supporting structure, including a single boom or fuselage.

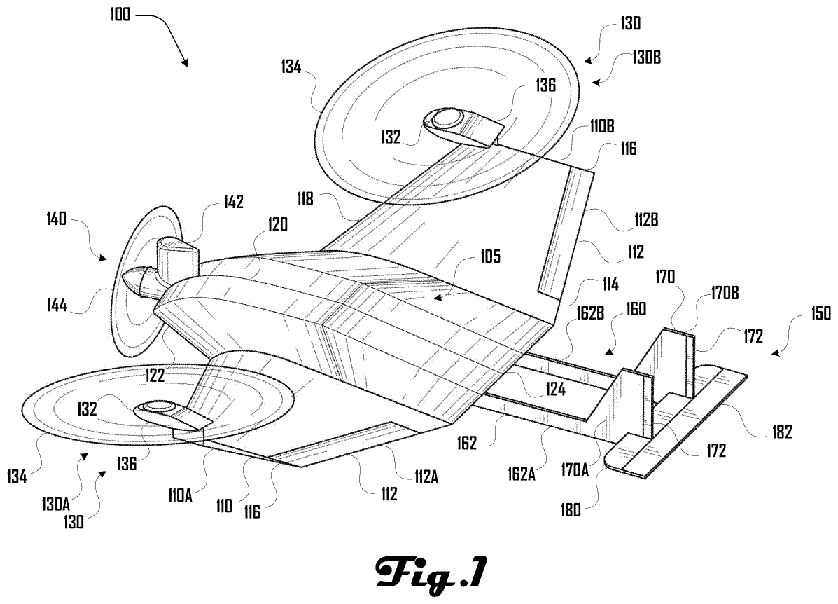

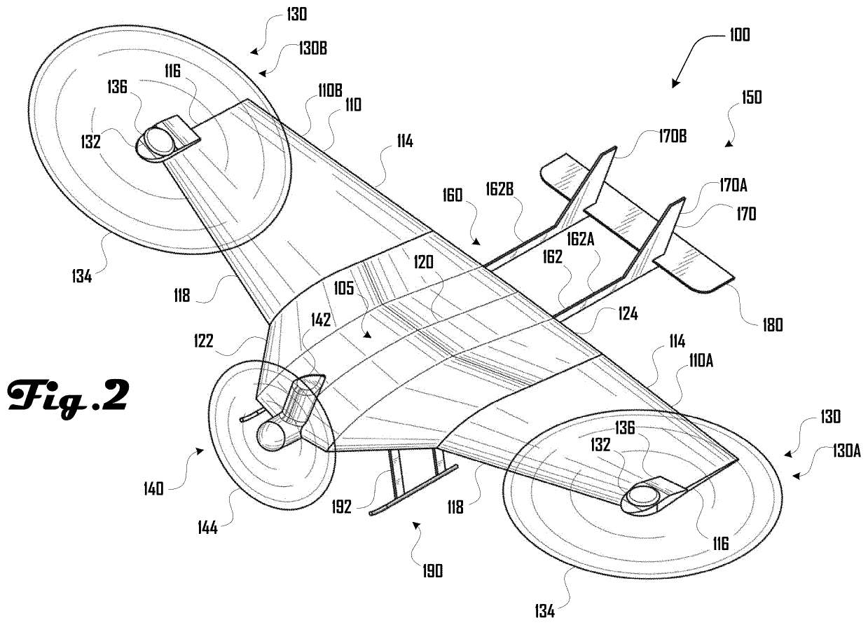

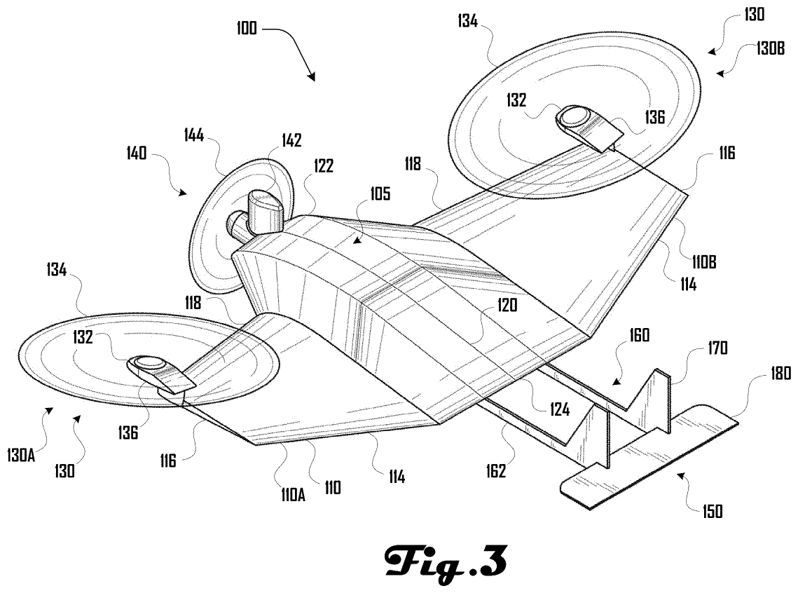

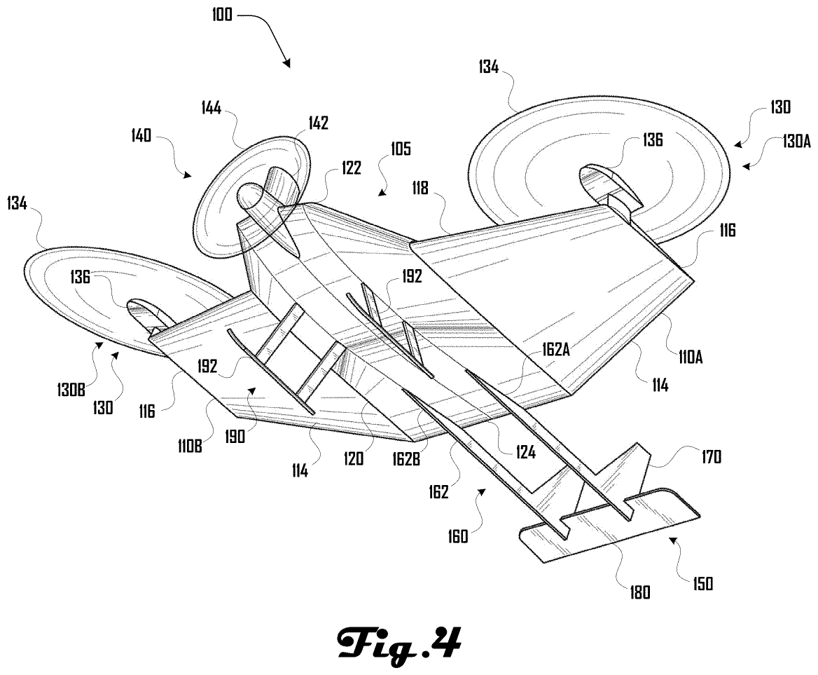

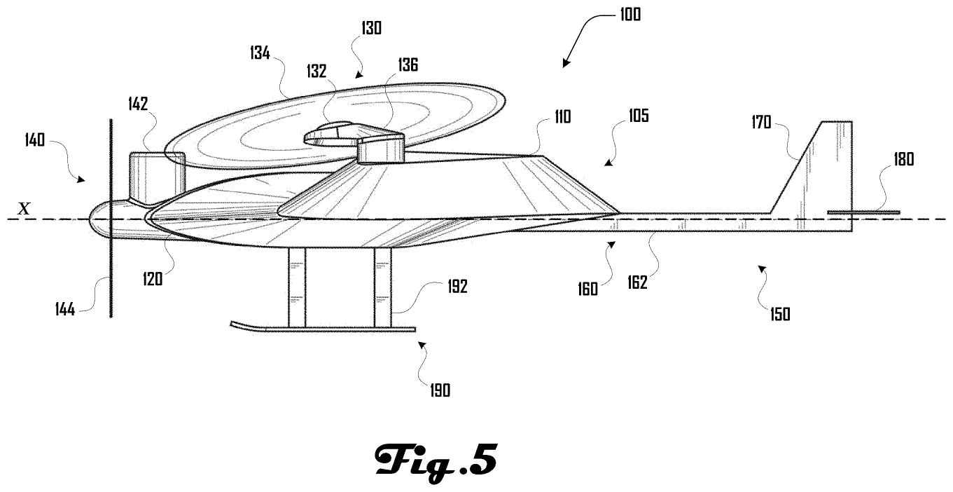

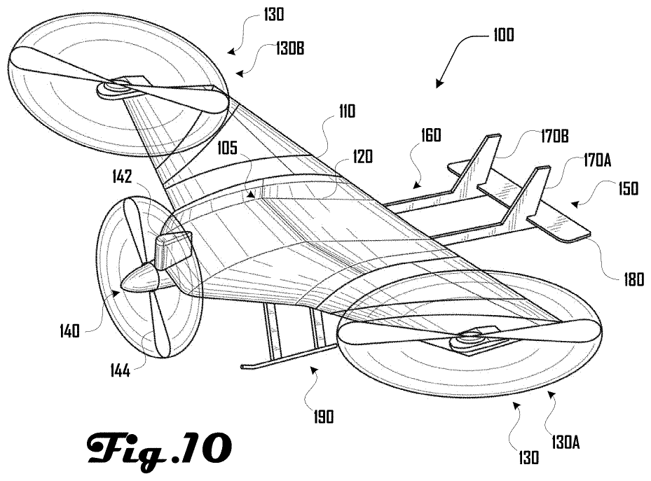

Turning to FIGS. 1-10, various views of example embodiments of an aircraft 100 are illustrated, where the aircraft 100 includes a fuselage 105 that comprises a pair of wings 110A, 110B extending from a central body 120. The wings 110 can comprise respective ailerons 112A, 112B extending along a portion of respective posterior edges 114 of the wings 110 with the ailerons 112 defining a portion of the peripheral ends 116 of the wings 110. The ailerons 112 can be rotatably coupled to the wings 110 and can be selectively rotated to control flight of the aircraft 100 (e.g., control the roll of the aircraft 100).

The wings 110 can be various suitable shapes including a trapezoid as shown in various examples herein. For example, the wings 110 can be defined by linear posterior and front edges 114, 118 that extend to a truncated elongated linear peripheral edge 116, with the lengths of the posterior and front edges 114, 118 of the wings 110 being longer than the length of the peripheral edge 116. However, in further embodiments, the wings 110 can be various suitable shapes and sizes. For example, in some embodiments, the posterior and/or front edges 114, 118 can be concave or convex. Additionally, in some examples, the peripheral edges 116 of the wings 110 can be a point, can be rounded, or the like.

The aircraft 100 can further include a pair of rotor assemblies 130A, 130B disposed extending upward from respective front exterior tips of the wings 110 (e.g., at a peripheral end 116 of the wing 110 at a front edge 118 of the wing 110). The rotor assemblies 130 can comprise a motor 132 with a plurality of blades 134 rotatably extending therefrom with the motor enclosed within a nacelle 136. Spinning of the blades 134 can generate lift as discussed herein. In various embodiments, any suitable number of blades 134 can be present extending from the motor 132 such as 2, 3, 4, 5, 6, 7, 8, 9, 10, 12, 18, 24, 36, 48, 72 or the like. For purposes of clarity, in various illustrations herein, the plurality or blades 134 are shown spinning such that the individual blades 134 are not explicitly shown. In some embodiments, the motors 132 can be electric motors; however, in further embodiments any suitable type of motor can be used, such as an internal combustion engine (ICE), or the like. While various embodiments herein illustrate a total of two rotor assemblies 130 on the wings 110 of the aircraft 100, further embodiments can include any suitable number of rotor assemblies 130 in any suitable location(s), with such a number including 2, 3, 4, 5, 6, 7, 8, 9, 10, 12, 18, 24, and the like.

The aircraft 100 can further include a propeller assembly 140 disposed at and extending from a front end 122 of the central body 120. The propeller assembly 140 can comprise a propeller motor 142 and a plurality of propeller blades 144. Spinning of the propeller blades 144 can generate cruise thrust as discussed herein. In various embodiments, any suitable number of propeller blades 144 can be present extending from the propeller motor 142 such as 2, 3, 4, 5, 6, 7, 8, 9, 10, 12, 18, 24, 36, 48, 72 or the like. For purposes of clarity, in various illustrations herein, the plurality or propeller blades 144 are shown spinning such that the individual propeller blades 144 are not explicitly shown. In some embodiments, the motor 142 can be an internal combustion engine (ICE); however, in further embodiments any suitable type of motor or propulsion element such as an electric motor, a jet engine, ducted fan, or the like. Also, while a single propeller assembly 140 is illustrated in various examples herein, further embodiments can include any suitable number of propeller assemblies in various suitable locations on the aircraft, with such a number including 2, 3, 4, 5, 6, 7, 8, 9, 10, 12 or the like.

The aircraft 100 can further include a tail assembly 150 extending from a rear end 124 of the central body 120. The tail assembly 150 can comprise a tail boom 160 that includes a pair of tail boom shafts 162A, 162B extending from the rear end 124 of the central body 120. Such tail boom shafts 162 can be elongated poles in various embodiments or can be any other suitable element. While various examples illustrate the tail boom 160 being defined by two boom shafts 162, in further embodiments, any suitable number of boom shafts 162 can define a boom tail 160, including 1, 2, 3, 4, 5, 6, 7, 8, 9, 10, 15, 25, 50, 100 or the like. In some embodiments, the tail boom 160 can be defined by the central body 120.

The tail assembly 150 can further include a pair of vertical tail fins 170A, 170B, which can extend vertically from respective tail boom shafts 162A, 162B in parallel planes. The tail fins 170 can each include a fin rudder 172 that is rotatably coupled to a posterior end of the respective tail fin 170. In various embodiments, movement of the fin rudders 172 can control yaw movement of the aircraft 100. While various examples include two tail fins 170, further embodiments can include any suitable number of tail fins 170 including 1, 2, 3, 4, 5, 6, 7, 8, 9, 10, 15, 25, 50, 100 or the like. In embodiments having a plurality of tail fins 170, such fins can extend vertically upward, downward, peripherally or in any suitable direction and may or may not extend in one or more parallel planes.

The tail assembly 150 can further include a horizontal tail 180, that is coupled to and extends from tail ends of the boom shafts 162A, 162B in a common plane with the tail boom shafts 162A, 162B that is perpendicular to the planes of the vertical tail fins 170A, 170B. The horizontal tail 180 can comprise an elevator 182 rotatably coupled to a posterior end of the horizontal tail 180. In various embodiments, movement of the elevator 182 can control the pitch of the aircraft 100 during flight.

The aircraft 100 can further comprise a set of landing gear 190 that can comprise a pair of legs 192 extending from the bottom of the central body 120. In some embodiments, the legs 192 can comprise landing skids; however, in further embodiments, any suitable elements can be present such as wheels, pontoons, and the like. In some embodiments, the landing gear 190 can be static structures or in some embodiments the landing gear 190 can be retractable, foldable, or the like.

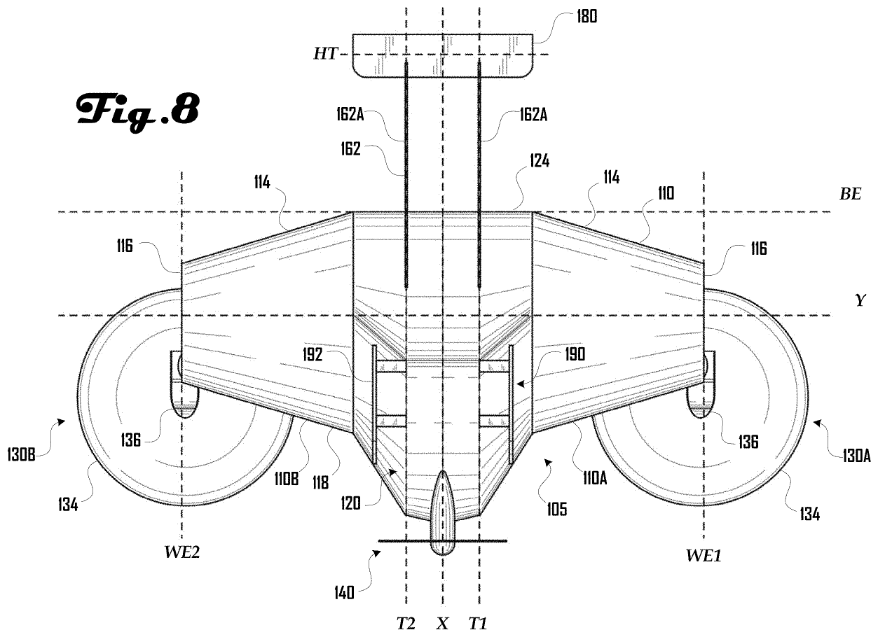

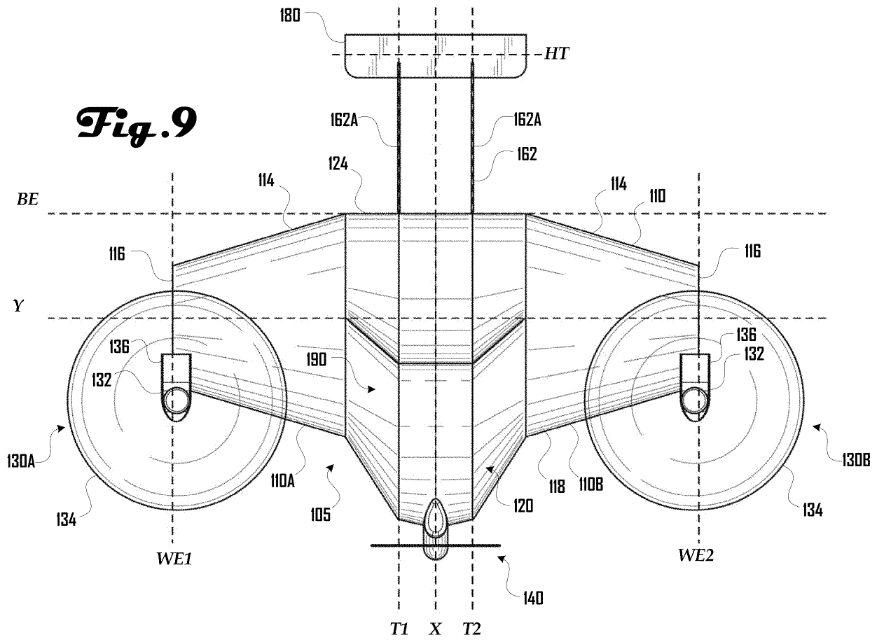

In various embodiments, the aircraft 100 can have a central plane or central axis of symmetry X (see e.g., FIGS. 8 and 9). Additionally, various elements can be disposed in parallel or can be disposed perpendicularly to such a central axis of symmetry X. For example, the peripheral ends 116 of the wings 110 can be planar and can have a respective axes WE1, WE2 that are parallel to the central axis of symmetry X. The tail boom shafts 162A, 162B can have a respective central axis T1, T2 that are parallel to the central axis of symmetry X. Additionally, in various embodiments, at least a portion of the rear end 124 of the central body 120 can be linear and can have a main axis BE that is perpendicular to the central axis X. The horizontal tail 180 can be planar in various embodiments and can have a main axis HT that is perpendicular to the central axis X.

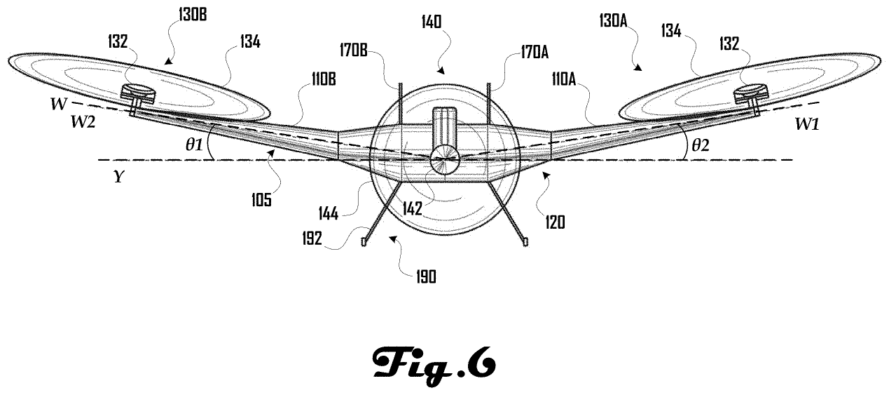

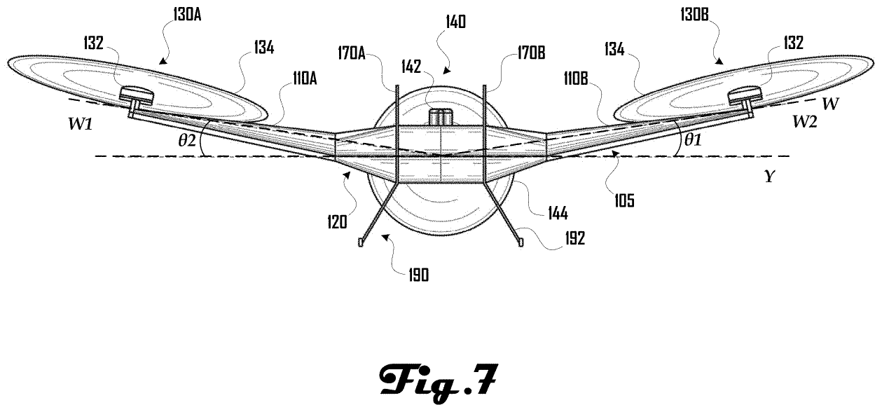

In various embodiments, the wings 110 can be angled in various suitable ways. For example, as shown in FIGS. 6 and 7, the wings 110A, 110B can have respective central axes W1, W2, with such central axes being angled relative to a horizontal plane or axis Y of the aircraft 100 by angles θ1 and θ2. Such angles θ1 and θ2 can be the same in various embodiments and can include various suitable angles such as −10°, −5°, 0°, 5°, 10°, 15°, 20°, 25°, 30°, 35°, 40°, 45°, 50°, or the like, or a range between such example values.

In various embodiments, the rotor assemblies 130 can be disposed such that the blades 134 rotate in a plane that is parallel to the central axes W1, W2 of the wings 110 or other orientation relative to the central axes W1, W2 of the wings 110 such as −10°, −9°, −8°, −7°, −6°, −5°, −4°, −3°, −2°, −1°, 0°, 1°, 2°, 3°, 4°, 5°, 6°, 7°, 8°, 9°, 10°, or the like, or a range between such example values. In various embodiments, the rotor assemblies 130 can be static, fixed or immovable; however, in some embodiments, the rotor assemblies 130 can be configured to pitch side-to-side, pitch front-to-back, rotate forward, backward, outwardly, inwardly, and the like. For example, pitching of the rotor assemblies can include pitching by −10°, −9°, −8°, −7°, −6°, −5°, −4°, −3°, −2°, −1°, 1°, 2°, 3°, 4°, 5°, 6°, 7°, 8°, 9°, 10°, or the like, or a range between such example values.

In one preferred embodiment, the aircraft 100 uses airplane aerodynamic controls and rotor assemblies 130 that are fixed pitch. Thrust of the rotor assemblies 130 can be modulated in some examples for lift and control by changing the torque of the driving motors. Additional aerodynamic surfaces such as flaps, airbrakes, and/or spoilers can be added in some embodiments for flight-path control. Variable-pitch rotor assemblies 130 in some embodiments may enhance control and efficiency.

An aircraft 100 of various embodiments can be any suitable size and can be an unstaffed aerial vehicle (UAV), can be piloted, can be remotely piloted or can be fully or partially autonomous. For example, in some embodiments, the aircraft can comprise a cockpit where one or more human users can operate the aircraft 100 or such a cockpit can be specifically absent in some embodiments. In some embodiments, the aircraft 100 can be large (e.g., with a with a wingspan of 90 m, 80 m, 70 m, 60 m 50 m, 40 m, 30 m, 20 m, or the like or a range between such values) or can be small (e.g. with a wingspan of 1 ft, 2 ft, 3 ft, 4 ft, 5 ft, 6 ft, 7 ft, 8 ft, 9 ft, 10 ft, 12 ft, 15 ft, 20 ft, 25 ft, 30 ft, 35 ft, 40 ft, 45 ft, 50 ft, 55 ft, or the like or a range between such values).

The aircraft 100 of various embodiments can be used or configured for various suitable tasks such as picking up a payload, delivering a payload, transporting a payload, reconnaissance, military missions, transporting passengers, or the like. Payloads can be any suitable size or shape or weight and can be carried internally within the aircraft 100, suspended from the aircraft 100, disposed on top of the aircraft 100, and the like.

The aircraft 100 and components thereof, or utilized in the various embodiments, may be constructed using any suitable method and with any suitable materials. Some or all the components may be cut out of panels (e.g., beech wood, polypropylene copolymer, metal, composite, etc.) into various parts. Such (e.g., prefabricated) panels may be cut into the various parts by die cutting, laser cutting, router, or any other suitable method. The various parts may then be attached to an internal frame of the aircraft 100, using cutouts (e.g., slots, etc.) to align the parts onto features (e.g., tabs, etc.) present on the internal structure or frame of the aircraft 100. The frame may be constructed similarly out of prefabricated materials (e.g., balsa, plywood, etc.) including castellated location-alignment tabs. The parts of the internal frame may be adhered (e.g., epoxied, etc.) into a rigid structure.

The structure of a blended wing-body of some examples of the aircraft 100 may be of any type suitable and appropriate to the construction of aircraft. Alternatively, in various forms of the invention, other manufacturing techniques (e.g., milling, routing, injection molding, 3D printing, vacuum forming, composite layup or any other suitable construction method) may be used to fabricate some or all of the various components of the aircraft 100.

In various embodiments, the aircraft 100 can be configured for vertical takeoff. For example, a method of takeoff of an aircraft 100 as discussed herein can include the aircraft 100 sitting on the ground (e.g., via landing gear 190) and then engaging the rotor assemblies 130 to generate lift sufficient to cause the aircraft 100 to lift off the ground vertically. The method can further include engaging the propeller assembly 140 to generate forward thrust, which can cause the aircraft 100 to move forward in the air. In various embodiments, the wings 110 can have an airfoil shape which can generate lift of the aircraft 100 based on forward movement. Accordingly, in various embodiments, lift generated by the rotor assemblies 130 can be increasingly reduced (e.g., by reducing the rate of rotation of the rotor blades 134) as increasing lift is generated by the wings 110 based on forward movement of the aircraft 100.

In some embodiments, rotation or lift generated by the rotor assemblies 130 can cease during flight with lift being substantially or exclusively generated via the wings 110 based on propulsion of the propellor assembly 140. However, in some embodiments, the rotor assemblies 130 can generate lift during flight of the aircraft 100. For example, rotors assemblies 130 on the top of the wings 110 can rotate slowly (e.g., lightly powered or in autorotation) carrying a small amount of lift and working synergistically with the wings 110 in cruise flight powered by propeller assembly 140. In various examples, such as where the rotors assemblies 130 are tip-mounted on the wings 110, in loiter, the lift of the rotor assemblies 130 can increase the effective span of the wings 110, reducing induced drag of the blades 134, nacelles 136, and the like. The rotor assemblies 130 in various embodiments can be positioned to have a favorable effect on cruise efficiency instead of being parasitic.

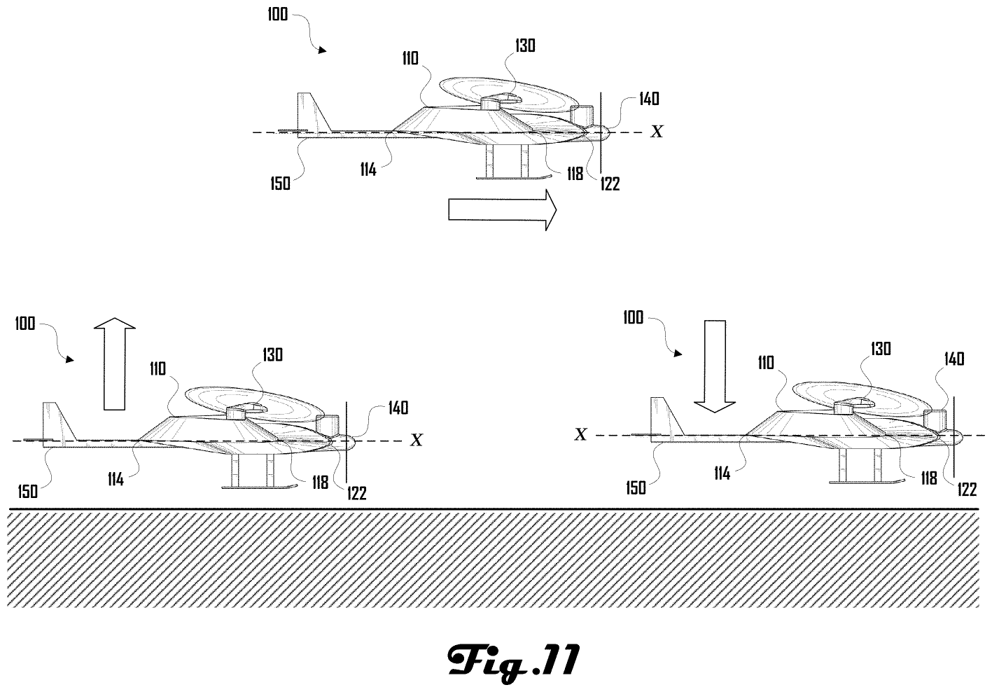

Also, in some embodiments, vertical takeoff of the aircraft 100 can be based exclusively on lift from the rotor assemblies 130 with propulsion of the propellor assembly 140 being absent during a vertical takeoff phase. However, in some embodiments, vertical or diagonal takeoff can include a combination of lift from the rotor assemblies 130 and propulsion via the propellor assembly 140. In various embodiments, takeoff of the aircraft can be a dynamic transient “jump” maneuver. For example, FIG. 11 illustrates an example embodiment of an aircraft 100 making a vertical takeoff at a first location, flying in to a second location and making a vertical landing.

One embodiment includes a method of operating an aircraft 100 that comprises vertical takeoff of the aircraft in a horizontal orientation with a central axis X of the aircraft parallel to the ground or perpendicular to gravity. In various embodiments, an upward propulsive force for takeoff can be generated substantially by the rotor assemblies 130 of the aircraft 100 (e.g., greater than or equal to 90%, 91%, 92%, 93%, 94%, 95%, 96%, 97%, 98%, 99%, 99.5% and the like or a range between such values) and in various embodiments, exclusively by the rotor assemblies 130 of the aircraft 100. In some embodiments, the aircraft can takeoff horizontally where an upward propulsive force component for takeoff can be generated substantially or exclusively by the rotor assemblies 130 of the aircraft 100 and a forward propulsive force component for takeoff can be generated substantially or exclusively by the propeller assembly 140.

After takeoff, the aircraft 100 transition to horizontal forward flight by increasing an amount of forward propulsive force generated by the propeller assembly 140 and reducing an upward propulsive force generated by the rotor assemblies 130. In various embodiments, forward flight generated by forward propulsive force generated by the propeller assembly 140 can generate aerodynamic lift based on an airfoil profile of at least the wings 110 and/or central body 120.

In various embodiments, the forward propulsive force generated by the propeller assembly 140 can be increased to greater than or equal to 75%, 80%, 85%, 90%, 91%, 92%, 93%, 94%, 95%, 96%, 97%, 98%, 99%, 99.5%, 100%, and the like, or a range between such values, of a maximum capable propulsive force compared to forward propulsive force generated by the propeller assembly 140, if any, during takeoff, which can in some examples include 1%, 2%, 3%, 4%, 5%, 10%, 15%, 20%, or the like, or a range between such values, of a maximum capable propulsive force.

In various embodiments, the upward propulsive force generated by the rotor assemblies 130 can be decreased from greater than or equal to 75%, 80%, 85%, 90%, 91%, 92%, 93%, 94%, 95%, 96%, 97%, 98%, 99%, 99.5%, 100%, and the like, or a range between such values, of a maximum capable propulsive force compared to forward propulsive force generated by the rotor assemblies 130, if any, during forward flight, which can in some examples include 1%, 2%, 3%, 4%, 5%, 10%, 15%, 20%, or the like, or a range between such values, of a maximum capable propulsive force.

The aerodynamic lift generated by the airfoil profile of at least the wings 110 and/or central body 120 can support the weight of the aircraft 100 and can thereby reduce power required from the rotor assemblies 130 to fly in the horizontal configuration compared to power that would be required for forward flight of the aircraft 100 in the horizontal orientation based on the rotor assemblies along. For example, in various embodiments, aerodynamic lift generated by the airfoil profile of at least the wings 110 and/or central body 120 can support various amounts of the weight of the aircraft 100 including at least 60%, 70%, 80%, 85%, 90%, 95%, 100%, 110%, 120%, 130% or the like, or a range between such example values.

In some embodiments, aerodynamic lift generated by the airfoil profile of at least the wings 110 and/or central body 120 can allow for the rotor assemblies 130 to be turned off or substantially powered down or can allow power of the rotor assemblies 130 to be reduced to 1%, 2%, 3%, 4%, 5%, 10%, 15%, 20%, or the like, of maximum power used by the rotor assemblies 130 during vertical or horizontal takeoff of the aircraft 100. In some embodiments, the blades 134 of the rotor assemblies 130 can provide aerodynamic lift based on forward flight of the aircraft 100, even with rotation of the rotor assemblies 130 removed or substantially reduced.

The aircraft 100 can travel from a first location to a second location in a horizontal flight configuration where with the central axis X of the aircraft 100 is parallel to the ground or perpendicular to gravity, or at a suitable angle of attack such as −20°, −15°, −10°, −9°, −8°, −7°, −6°, −5°, −4°, −3°, −2°, −1°, 0°, 1°, 2°, 3°, 4°, 5°, 6°, 7°, 8°, 9°, 10°, 15°, 20° or the like, or a range between such values. In one preferred embodiment, the angle of attack is between 5° and 10°.

At the second location, the aircraft 100 After takeoff, the aircraft 100 transition vertical or diagonal landing by increasing an amount upward propulsive force generated by the rotor assemblies 130 and reducing forward propulsive force generated by the propeller assembly 140. For example, the propellor assembly 140 can be turned off or substantially powered down or can allow power of the propellor assembly 140 to be reduced to less than or equal to 1%, 2%, 3%, 4%, 5%, 10%, 15%, 20%, or the like, of maximum power used by the propellor assembly 140 during vertical or horizontal forward flight of the aircraft 100. The rotor assemblies can be greater than or equal to 75%, 80%, 85%, 90%, 91%, 92%, 93%, 94%, 95%, 96%, 97%, 98%, 99%, 99.5%, 100%, and the like, or a range between such values, of a maximum capable propulsive force during landing. The aircraft 100 can then land vertically or diagonally.

Similarly, the aircraft 100 in various embodiments does not hover to land. For example, in some embodiments, a method of landing an aircraft 100 can include maneuvering the aircraft 100 close to a landing location (e.g., via lift from the rotor assemblies 130, lift of the wings 110 and/or propulsion of the propellor assembly 140) and generating a burst of thrust from the rotor assemblies 130 to arrest vertical and/or forward motion of the aircraft 100 just before touch-down (e.g., before landing on the landing gear 190). Such an approach to landing can be near-vertical in autorotation in some examples with an electric power burst to the rotor assemblies 130 (to increase rotation rate of the blades 134) to arrest the final sink rate.

In some embodiments, a method of landing an aircraft 100 can include flying an aircraft 100 to a landing location via thrust, propulsion, and/or lift generated by the rotor assemblies 130, propellor assembly 140 and/or wings 110. The aircraft 100 can maintain forward velocity toward the landing location, and when proximate to the landing location, the rotor assemblies 130 can increase their thrust (e.g., via increasing the rate of spin of the blades 134) to substantially reduce or stop vertical and/or forward motion of the aircraft 100, which can allow the aircraft 100 to land at the landing location.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

What is claimed is:

1. A method of operating an aircraft, the method comprising:
vertical takeoff of an aircraft in a horizontal orientation with a central axis X of the aircraft parallel to the ground, the aircraft comprising:
a central body,
a pair of wings extending from the central body and comprising respective ailerons extending along a portion of respective posterior edges of the wings with the ailerons defining a portion of peripheral ends of the wings, the ailerons rotatably coupled to the wings and configured to be selectively rotated to control flight of the aircraft, including controlling roll of the aircraft, the wings having a trapezoid shape and defined by linear posterior and front edges that extend to a truncated elongated linear peripheral edge, with the lengths of the posterior and front edges of the wings being longer than the length of the peripheral edge, the wings having an airfoil profile,
a pair of rotor assemblies disposed extending upward from respective front exterior tips of the wings at a peripheral end of the wing at a front edge of the wing, the rotor assemblies comprising an electric motor with a plurality of blades rotatably extending therefrom with the electric motor enclosed within a nacelle, with spinning of the blades generating upward propulsive force for the vertical takeoff,
a propeller assembly disposed at and extending from a front end of the central body and having a central rotational axis coincident with the central axis X of the aircraft, the propeller assembly comprising an internal combustion engine (ICE) and a plurality of propeller blades, and
a tail assembly extending from a rear end of the central body, the tail assembly comprising:
a tail boom that includes a pair of tail boom shafts extending from the rear end of the central body,
a pair of vertical tail fins that extend vertically from respective tail boom shafts in parallel planes, the vertical tail fins each including a fin rudder that is rotatably coupled to a posterior end of the respective tail fin with movement of the fin rudders configured to control yaw movement of the aircraft, and
a horizontal tail coupled to and extending from tail ends of the tail boom shafts in a common plane with the tail boom shafts that is perpendicular to the parallel planes of the vertical tail fins, the horizontal tail comprising an elevator rotatably coupled to a posterior end of the horizontal tail, the elevator configured to control pitch of the aircraft during flight;
after takeoff, transitioning the aircraft to a horizontal forward flight configuration by increasing an amount of forward propulsive force generated by the propeller assembly from 0% to at least 90% of a propeller assembly maximum and reducing the upward propulsive force generated by the rotor assemblies from at least 90% of a rotor assembly maximum to 0%;
flying the aircraft from a first location to a second location in the horizontal forward flight configuration with an angle of attack of between 0° and 15° relative to the central axis X, with forward flight generating aerodynamic lift that supports at least 95% of the weight of the aircraft;
transitioning the aircraft to a vertical landing configuration at the second location by decreasing an amount of forward propulsive force generated by the propeller assembly from at least 90% to 0% of a propeller assembly maximum and increasing the upward propulsive force generated by the rotor assemblies from 0% to at least 90% of a rotor assembly maximum; and
landing the aircraft vertically at the second location on the ground.

2. The method of operating an aircraft of claim 1, wherein the aircraft has exactly two, and no more than two, rotor assemblies.

3. The method of operating an aircraft of claim 1, wherein the aircraft has exactly one, and no more than one, propeller assembly.

4. A method of operating an aircraft, the method comprising:
vertical takeoff of an aircraft in a horizontal orientation with a central axis X of the aircraft parallel to the ground, the aircraft comprising:
a pair of wings extending from a central body, the wings having an airfoil profile,
a pair of rotor assemblies extending from the wings, the rotor assemblies comprising an electric motor with a plurality of blades, with spinning of the blades generating upward propulsive force for the vertical takeoff,
a propeller assembly disposed at and extending from a front end of the central body and having a central rotational axis coincident with the central axis X of the aircraft, the propeller assembly comprising an internal combustion engine (ICE) and a plurality of propeller blades, and
a tail assembly extending from a rear end of the central body;
after takeoff, transitioning the aircraft to a horizontal forward flight configuration by increasing an amount of forward propulsive force generated by the propeller assembly from equal to or less than 5% to at least 85% of a propeller assembly maximum and reducing the upward propulsive force generated by the rotor assemblies from at least 85% of a rotor assembly maximum to equal to or less than 5%;
flying the aircraft from a first location to a second location in the horizontal forward flight configuration with an angle of attack of between 0° and 15° relative to the central axis X, with forward flight generating aerodynamic lift that supports at least 90% of the weight of the aircraft; and
transitioning the aircraft to a vertical landing configuration at the second location by decreasing an amount of forward propulsive force generated by the propeller assembly from at least 85% to equal to or less than 5% of a propeller assembly maximum and increasing the upward propulsive force generated by the rotor assemblies from equal to or less than 5% to at least 85% of a rotor assembly maximum.

5. The method of operating an aircraft of claim 4, wherein the wings extending from a central body comprise respective ailerons extending along a portion of respective posterior edges of the wings with the ailerons defining a portion of peripheral ends of the wings, the ailerons rotatably coupled to the wings and configured to be selectively rotated to control flight of the aircraft, including controlling roll of the aircraft.

6. The method of operating an aircraft of claim 4, wherein the wings have a trapezoid shape and are defined by linear posterior and front edges that extend to a truncated elongated linear peripheral edge, with the lengths of the posterior and front edges of the wings being longer than the length of the peripheral edge.

7. The method of operating an aircraft of claim 4, wherein the rotor assemblies are disposed extending upward from the wings.

8. The method of operating an aircraft of claim 7, wherein the rotor assemblies are disposed extending upward from respective front exterior tips of the wings at a peripheral end of a respective wing at a front edge of the respective wings.

9. The method of operating an aircraft of claim 4, wherein the tail assembly comprises:
a tail boom that includes a pair of tail boom shafts extending from the rear end of the central body,
a pair of vertical tail fins that extend vertically from respective tail boom shafts in parallel planes, the vertical tail fins each including a fin rudder that is rotatably coupled to a posterior end of the respective tail fin with movement of the fin rudders configured to control yaw movement of the aircraft, and
a horizontal tail coupled to and extending from tail ends of the tail boom shafts in a common plane with the tail boom shafts that is perpendicular to the parallel planes of the vertical tail fins, the horizontal tail comprising an elevator rotatably coupled to a posterior end of the horizontal tail, the elevator configured to control pitch of the aircraft during flight.

10. A method of operating an aircraft, the method comprising:
takeoff of an aircraft, the aircraft comprising:
a pair of wings extending from a central body, the wings having an airfoil profile,
a pair of rotor assemblies generating upward propulsive force for the takeoff, and
a propeller assembly disposed at and extending from a front end of the central body;
after the takeoff, transitioning the aircraft to a forward flight configuration by increasing an amount of forward propulsive force generated by the propeller assembly from equal to or less than 10% to at least 80% of a propeller assembly maximum and reducing the upward propulsive force generated by the rotor assemblies from at least 80% of a rotor assembly maximum to equal to or less than 10%;
flying the aircraft from a first location to a second location in the forward flight configuration; and
transitioning the aircraft to a landing configuration at the second location by decreasing an amount of forward propulsive force generated by the propeller assembly and increasing the upward propulsive force generated by the rotor assemblies.

11. The method of operating an aircraft of claim 10, wherein the takeoff comprises vertical takeoff of an aircraft in a horizontal orientation with a central axis X of the aircraft parallel to the ground.

12. The method of operating an aircraft of claim 10, wherein the rotor assemblies extend from the wings.

13. The method of operating an aircraft of claim 10, wherein the rotor assemblies comprise an electric motor.

14. The method of operating an aircraft of claim 10, wherein the propeller assembly has a central rotational axis coincident with a central axis X of the aircraft.

15. The method of operating an aircraft of claim 10, wherein the propeller assembly comprising an internal combustion engine (ICE).

16. The method of operating an aircraft of claim 10, wherein the flying the aircraft from the first location to the second location in the forward flight configuration, includes flying with an angle of attack of between 0° and 20° relative to a central axis X of the aircraft.

17. The method of operating an aircraft of claim 10, wherein the flying the aircraft from the first location to the second location in the forward flight configuration generates aerodynamic lift that supports at least 80% of the weight of the aircraft.

18. The method of operating an aircraft of claim 17, wherein the generated aerodynamic lift that supports at least 80% of the weight of the aircraft is generated based at least in part on the airfoil profile of the wings.

19. The method of operating an aircraft of claim 10, wherein the transitioning the aircraft to the landing configuration at the second location comprises decreasing an amount of forward propulsive force generated by the propeller assembly from at least 80% to equal to or less than 10% of a propeller assembly maximum.

20. The method of operating an aircraft of claim 10, wherein the transitioning the aircraft to the landing configuration at the second location comprises increasing the upward propulsive force generated by the rotor assemblies from equal to or less than 10% to at least 80% of a rotor assembly maximum.
